(19) United States
(12) Patent Application Publication
(10) Pub. No.: US 2007/0295564 A1
(43) Pub. Date: Dec. 27, 2007

(54) DOOR APPARATUS

(76) Inventor: Seiichi SOMEYA, Fuchu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/847,373

(22) Filed: Aug. 30, 2007

Related U.S. Application Data
(63) Continuation of application No. PCT/JP06/07766, filed on Apr. 12, 2006.

(30) Foreign Application Priority Data
Apr. 12, 2005 (JP) 2005-114810

(51) Int. Cl. B66B 13/12

(52) U.S. Cl. 187/319; 187/330

(57) ABSTRACT

A door apparatus is provided with engaging elements for actuating a locking mechanism of a hall door and a pair of engaging vanes which can be opened away from or closed toward each other so that they pinch the engaging elements between them to hold the locking mechanism in an inactivated state when in their closed state. The closed state of the two engaging vanes is maintained by a cam mechanism and a retention mechanism. The closed state of the two engaging vanes can also be maintained by the retention mechanism after the hall door is moved in a door closing direction to cancel maintenance by contact with the cam mechanism. Both the engaging vanes are moved in an opening direction to actuate the locking mechanism by means of a reaction force generated when the hall door reaches a door-stop position and stops there.

### CROSS REFERENCE TO RELATED APPLICATIONS

This is a Continuation Application of PCT Application No. PCT/JP2006/307766, filed Apr. 12, 2006, which was published under PCT Article 21(2) in Japanese.

This application is based upon and claims the benefit of priority from prior Japanese Patent Application No. 2005-114810, filed Apr. 12, 2005, the entire contents of which are incorporated herein by reference.

### BACKGROUND OF THE INVENTION

1. Field of the Invention

The present invention relates to an elevator door apparatus provided with an engaging device that causes a car door and a hall door to engage with each other when the car arrives at a floor.

2. Description of the Related Art

An elevator hall in a building is provided with a doorway through which people get into and out of an elevator car. A sliding hall door is provided in the doorway. Normally, this hall door is closed. When the car that travels in the elevator shaft arrives at the elevator hall and stops there, the hall door opens and closes urged by a driving force from a car door. Further, the hall door is provided with a locking mechanism. When the hall door is closed, the locking mechanism locks the hall door. The locking mechanism is released when operation for opening the hall door is started.

Provided between the car door and the hall door is an engaging device that serves to transmit the driving force of the car door to the hall door and actuate the locking mechanism. This engaging device is provided with a pair of engaging vanes that extend vertically. The engaging vanes are supported by a parallel link mechanism that is attached to the car door, and they are kept parallel to each other as a clearance between them is changed.

The locking mechanism is provided with two engaging rollers as engaging elements for actuating a locking lever that locks the hall door. The two engaging rollers are interposed between the pair of engaging vanes. The car door and the hall door engage each other as both the engaging rollers are pinched between the pair of engaging vanes. In consequence, the car door and the hall door can move in association with each other. If the pinched state is canceled, moreover, the locking lever is actuated to lock the hall door.

If the hall door is closed so that the actuation of the locking mechanism of the hall door is completed, the width of the clearance between the pair of engaging vanes increases to form gaps from the engaging rollers. In consequence, the car can travel in the elevator shaft without causing the engaging vanes to collide with the engaging rollers.

Various engaging devices have been proposed so far. In one engaging device, for example, a cam roller is attached to one of paired engaging vanes that are supported by a parallel link mechanism. A cam plate is provided on an upper part of the car door. As the door is closed, the cam roller is guided along the cam plate. If the cam roller moves up or down along the cam plate immediately before the hall door is closed, the clearance between a pair of engaging rollers changes. In consequence, the locking mechanism may be actuated or the car door and the hall door may be disengaged from each other.

In another engaging device, moreover, one of engaging vanes is fixed to a car door, while the other engaging vane is supported on the one engaging vane by a parallel link mechanism. A cam roller is attached to the other engaging vane. This cam roller is guided along a cam plate over a car door. The cam roller, like the one described before, actuates a locking mechanism and releases engagement immediately before the car door is closed.

The two doors must be disengaged from each other in order to enable the car to move up and down with each door fully closed. According to the engaging device provided with the cam mechanism that is composed of the cam roller and the cam plate, as described above, the two doors are disengaged from each other in a manner such that gaps are formed between the engaging vanes and the engaging rollers immediately before the doors are closed.

If the engagement between the two doors is released with the gaps formed between the engaging vanes and the engaging rollers immediately before the doors are closed, however, the transmission of the driving force from the engaging vanes to the engaging rollers is cut off inevitably. After a position for the time immediately before the hall door is closed is reached, therefore, operation is performed so that the hall door is securely closed by the agency of a door closer that utilizes a weight or a spring mechanism.

On the other hand, there is also another apparatus in which a car door and a hall door are disengaged from each other without using any cam mechanism, such as the one described above. This apparatus is provided with two support levers that are coupled to engaging vanes to form a parallel link mechanism. One of the support levers is supported for rotation around the axis of a pivot that is fixed to a car door. Further, a rope for door drive and the pivot are connected to each other by an operating lever. The rope can be driven even after a hall door is closed. When this is done, a driving force of the rope is transmitted to a separately provided parallel link mechanism, whereupon a locking mechanism is actuated to release engagement between the car door and the hall door.

There is also an alternative apparatus that uses no cam mechanism. In this apparatus, one engaging vane is provided for sliding motion relative to a car door, and the other engaging vane, a car door, and a belt for car door drive are connected to one another by levers that are supported individually thereon for rotation. The hall door is closed by the agency of these levers. Even after the car door is closed, moreover, the drive belt can continue to be driven in a closing direction. Thus, the door engagement can be released by driving only the engaging vanes even after the car door is closed. In the door apparatus constructed in this manner, the driving force of the rope or belt is transmitted until the closure of the hall door is completed at the time of door closing.

If there is any difference between temperatures inside and outside a high-rise building in winter, in particular, strong updrafts are generated in an elevator shaft. Therefore, a great pressure difference is caused between the interior of the shaft and the hall. For example, a pressure difference having been canceled while the door is open in the hall near an entrance on the first floor sometimes may suddenly increase immediately before the door is closed. As the drag from the hall into the shaft increases, a heavy load starts to act on a guide device of a hall door. In consequence, a frictional resistance or an atmospheric pressure on a door-stop surface may possibly increase, so that the hall door fails to be closed securely. These days, in particular, a smoke-proof door with enhanced closeness may possibly be used as a hall door that doubles as disaster prevention equipment. Accordingly, a difference between pressures inside and outside the door is liable to increase, so that a trend toward the aforesaid disadvantage is increasing.

For the aforementioned door apparatus provided with the cam mechanism that is composed of the cam roller and the cam plate, it is effective to enhance the force of the door closer as a measure to counter the drag. In order to enhance the force of the door closer, however, the weight or the spring mechanism must be increased in size. Thus, there is an influence on an installation space for the elevator. If the force of the door closer is enhanced, moreover, the driving force of the door apparatus must be enhanced correspondingly, so that a drive unit becomes large-sized. Further, the economical efficiency is impaired if this countermeasure is taken for each of many hall doors installed on each floor.

In the latter door apparatus described above, moreover, the mechanisms are so complicated that their adjustment is hard and the economical efficiency is inevitably poor. In door apparatuses of this type, furthermore, the position of the car door is not aligned with the position of the drive rope or the belt, so that the structure is subject to relative displacement. Accordingly, a center-opening door requires a mechanism for operating its left- and right-hand doors in association with each other, as well as the rope and the belt, so that the mechanisms are more complicated.

### BRIEF SUMMARY OF THE INVENTION

A door apparatus according to the present invention is configured so that a driving force produced by a car door can be transmitted to a hall door to close the hall door securely without complicating an engaging device for the hall door and the car door. Further, normal operation can be performed even when a drag that acts on the hall door is high.

According to an aspect of the present invention, a door apparatus includes an engaging device which causes one of car doors and one of hall doors to engage each other, the door apparatus comprising: urging means which urges a first engaging vane and a second engaging vane provided on the one of the car doors in an opening direction; a cam mechanism which holds the first engaging vane and the second engaging vane in a closed state, resisting the urging means, and cancels the maintenance of the closed state immediately before the hall doors reach a door-stop position after moving in a door closing direction; and a retention mechanism which holds the first engaging vane and the second engaging vane in the closed state, resisting the urging means, maintains the closed state of the first engaging vane and the second engaging vane even after the maintenance of the closed state by the cam mechanism is canceled, and cancels the maintenance of the closed state by means of a reaction force in response to stopping of the hall doors by door abutting.

According to an aspect of the present invention, a door apparatus, is characterized by comprising a locking mechanism for locking the hall doors in a locked state.

According to an aspect of the present invention, an elevator door apparatus comprises sliding-type car doors which open and close an entrance of a car; sliding-type hall doors which open and close an entrance of an elevator hall and of which respective distal end edges on the door-stop side move in association with the car doors in the door closing direction, preceding respective distal end edges of the car doors on the door-stop side; a drive unit for driving one of the car doors and a locking mechanism for locking the hall doors in a locked state; and an engaging device which causes one of the car doors and one of the hall doors to engage each other by operating the one car door in a state such that the car arrives at the elevator hall, thereby transmitting a driving force of one of the car doors to one of the hall doors and actuating the locking mechanism in response to release of the engagement, the engaging device including a first engaging element which is provided on one of the hall doors and transmits the driving force of the one of the car doors to the one of the hall doors a second engaging element which is also provided on the one of the hall doors and is displaced relatively to the first engaging element, thereby actuating the locking mechanism, an engaging vane mechanism which includes a first engaging vane and a second engaging vane provided on the one of the car doors and configured to be translated toward and away from each other in closing and opening directions by a parallel link mechanism, such that the first engaging vane and the second engaging vane are moved toward each other to be closed together, whereby the first engaging element and the second engaging element are pinched between the two engaging vanes so that the second engaging element is held in a position where the locking mechanism is released, and that the first and second engaging vanes are moved away from each other to be opened as the hall doors are stopped by door abutting, whereby the first engaging element and the second engaging element are released from the pinch so that the locking mechanism is actuated, urging means which urges the first and second engaging vanes in the opening direction, a cam mechanism which holds the first engaging vane and the second engaging vane in a closed state, resisting the urging means, and cancels the maintenance of the closed state immediately before the hall doors reach a door-stop position after moving in a door closing direction, and a retention mechanism which holds the first engaging vane and the second engaging vane in the closed state, resisting the urging means, maintains the closed state of the first engaging vane and the second engaging vane even after the maintenance of the closed state by the cam mechanism is canceled, and cancels the maintenance of the closed state by means of a reaction force in response to stopping of the hall doors by door abutting.

According to this configuration, the driving force of the car door is transmitted to the hall door until the hall door is closed up, so that accurate door closing can be achieved by maintaining an appropriate self-closing force until the hall door is closed up, without enhancing the force of a door closer or complicating the engaging device for the hall door and the car door.

According to an aspect of the present invention, an elevator door apparatus is characterized in that the urging means urges the first engaging vane and the second engaging vane in the opening direction by means of a balance weight or a spring member.

According to an aspect of the present invention, an elevator door apparatus is characterized in that the retention mechanism holds the first engaging vane and the second engaging vane in the closed state by means of the magnetic attraction of a magnet.

According to an aspect of the present invention, an elevator door apparatus is characterized in that the retention mechanism is provided on one of the car doors so as to face the first engaging vane or the second engaging vane and holds both the engaging vanes in the closed state by coming into close contact with the first engaging vane or the second engaging vane by means of magnetic attraction.

According to an aspect of the present invention, an elevator door apparatus is characterized in that the magnet is configured to be adjusted in mounting position in order to adjust a closing width of the two engaging vanes.

According to an aspect of the present invention, a n elevator door apparatus is characterized in that impact damping means is provided between the magnet and the first engaging vane or the second engaging vane and/or between the magnet and a magnet support portion in order to suppress an impact noise caused when the magnet come into close contact with the first engaging vane or the second engaging vane.

According to an aspect of the present invention, a n elevator door apparatus is characterized in that the magnet is configured to be adjusted in mounting position so that an area of close contact with the first engaging vane or the second engaging vane is changed to enable adjustment of a retention force for holding the two engaging vanes in the closed state by adjusting the mounting position.

According to an aspect of the present invention, a n elevator door apparatus is characterized in that the car doors are configured to be fitted with a plurality of magnets such that a retention force for holding the two engaging vanes in the closed state is adjustable by increasing or reducing the magnets in number.

According to an aspect of the present invention, a n elevator door apparatus is characterized in that the engaging vane located on the door closing direction side of the car door, out of the two engaging vanes, is fixed to the car door, and the other engaging vane is translated by the parallel link mechanism.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a front view showing a structure of a part of an elevator door apparatus according to a first embodiment of the present invention;

FIG. 2 is a front view showing a structure of a part of an engaging device of the door apparatus;

FIG. 3 is a front view showing a structure of a locking mechanism of the door apparatus;

FIG. 4 is an explanatory view showing a first-stage state in the course of operation for closing doors of the door apparatus;

FIG. 5 is an explanatory view showing a second-stage state;

FIG. 6 is an explanatory view showing a third-stage state;

FIG. 7 is an explanatory view showing a final-stage state;

FIG. 8 is a front view showing a structure of a part of an engaging device in an elevator door apparatus according to a second embodiment of the present invention;

FIG. 9 is a front view showing a structure of a part of an engaging device in an elevator door apparatus according to a third embodiment of the present invention;

FIG. 10 is a front view showing a structure of a part of an engaging device in an elevator door apparatus according to a fourth embodiment of the present invention;

FIG. 11 is a front view showing a structure of a part of an engaging device in an elevator door apparatus according to a fifth embodiment of the present invention;

FIG. 12 is a front view showing a magnet mounting structure in the engaging device;

FIG. 13 is a front view showing a structure of a part of an engaging device in an elevator door apparatus according to a sixth embodiment of the present invention; and

FIG. 14 is a front view showing a structure of a part of an elevator door apparatus according to a seventh embodiment of the present invention.

### DETAILED DESCRIPTION OF THE INVENTION

Embodiments of the present invention will now be described with reference to the drawings.

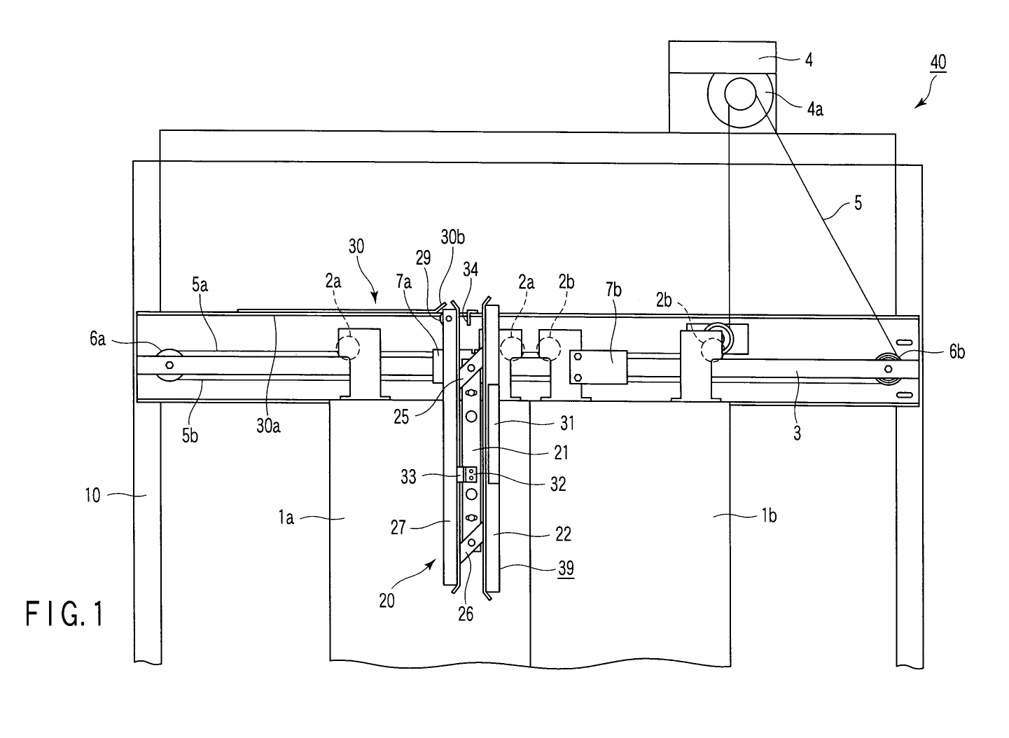

A first embodiment will be described with reference to FIGS. 1 to 7.

FIG. 1 is a front view showing a structure of a part of an elevator door apparatus according to a first embodiment of the present invention, in which a center-opening car door apparatus at an entrance (not shown) in front of a car (not shown) is viewed from the side of an elevator hall. In an elevator door apparatus 40 according to the present embodiment, a frame member 10 is attached to the front face of the car. A hanger rail 3, which is long from side to side, is mounted horizontally to the upper part of the frame member 10. A pair of car doors 1a and 1b are suspended from the hanger rail 3 by means of hanger rollers 2a and 2b on their respective upper parts so as to be located left and right, respectively. These car doors 1a and 1b can move from side to side along the hanger rail 3, thereby opening and closing the entrance in front of the car.

A door drive unit 4 for use as a drive mechanism is provided on top of the frame member 10. Further, pulleys 6a and 6b are arranged individually for rotation at the opposite end portions of the hanger rail 3. A door drive belt 5 is passed around and between a sheave 4a of the drive unit 4 and the pulleys 6a and 6b under a predetermined tension.

A halfway portion of the belt 5 extends along and parallel to the hanger rail 3. The left-hand car door la is connected to an upper part 5a of the belt 5 by a bracket 7a. On the other hand, the right-hand car door 1b is connected to a lower part 5b of the belt 5 by a bracket 7b. Thus, the left- and right-hand car doors 1a and 1b are coupled directly to the belt 5 so that they can move bisymmetrically in linkage with each other.

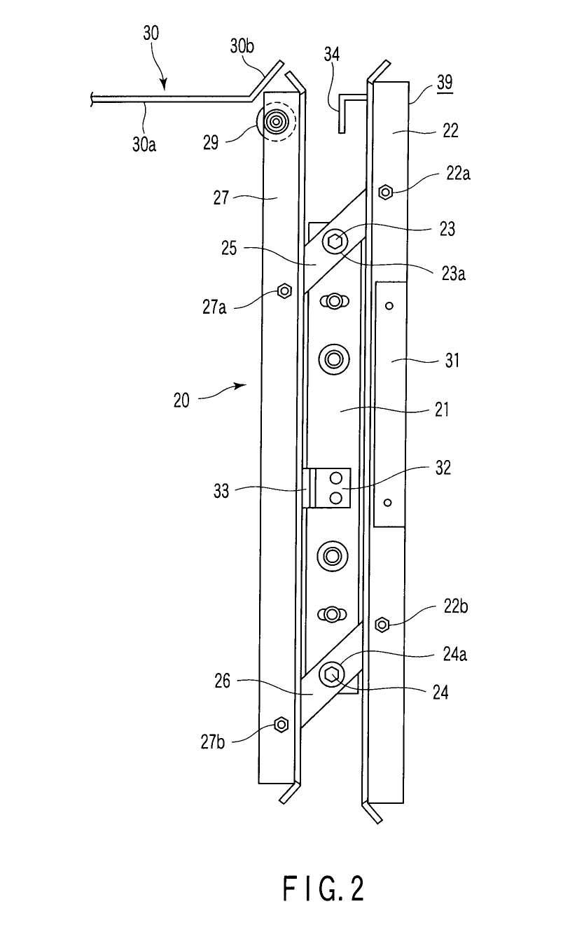

An engaging device 20 is attached to the left-hand car door 1a. It engages a hall door of a hall door device (not shown) and transmits a driving force produced by the car door 1a to the hall door. A configuration of the engaging device 20 will now be described with reference to FIGS. 1 and 2.

A base plate 21 is attached to the car door 1a of the door apparatus. Shafts 23 and 24 are attached individually to two spots, upper and lower, of the base plate 21. Middle portions of link plates 25 and 26 that constitute a parallel link mechanism are rockably mounted on the shafts 23 and 24 by bearings 23a and 24a, respectively.

A first engaging vane 22 with an L-shaped cross section is rockably mounted on respective end portions of the link plates 25 and 26 on one side of the shafts 23 and 24 by means of shafts 22a and 22b, respectively. A second engaging vane 27 is rockably mounted on the other-side end portions by means of shafts 27a and 27b, respectively.

The first and second engaging vanes 22 and 27, which constitute an engaging vane mechanism 39, extend in the vertical direction and face each other in parallel relation. As the link plates 25 and 26 rock around the shafts 23 and 24, respectively, the first and second engaging vanes 22 and 27 are translated toward or away from each other in a closing or opening direction.

The link plates 25 and 26 are inclined upward to the right as in FIGS. 1 and 2. When the link plates 25 and 26 rock clockwise, the first engaging vane 22 descends, and the second engaging vane 27 ascends. As this is done, the two engaging vanes 22 and 27 are translated toward each other in the closing direction. When the link plates 25 and 26 rock counterclockwise, on the other hand, the first engaging vane 22 ascends, and the second engaging vane 27 descends. As this is done, the two engaging vanes 22 and 27 are translated away from each other in the opening direction. The clockwise rocking motion of each of the link plates 25 and 26 is restricted within a fixed range by a stopper (not shown).

A cam roller 29 that constitutes a cam mechanism is rotatably attached to the upper part of the second engaging vane 27. The roller 29 is configured to contact with a cam plate 30 that is attached to the frame member 10 shown in FIG. 1. The cam plate 30 includes a horizontal portion 30a, which extends horizontally covering an elongated section, and a slope portion 30b extending diagonally upward from one end portion of the horizontal portion 30a. A roller stopper 34 is attached to the frame member 10 so as to face the slope portion 30b at a distance therefrom.

A balance weight 31 as urging means is attached to an intermediate portion of the first engaging vane 22. The balance weight 31 urges the link plates 25 and 26 to rock clockwise.

The base plate 21 is fitted with a magnet 33 for use as a retention mechanism by a bracket 32. When the two engaging vanes 22 and 27 are in a closed state such that they approach each other, the second engaging vane 27 is brought into close contact with the magnet 33 to maintain its closed state.

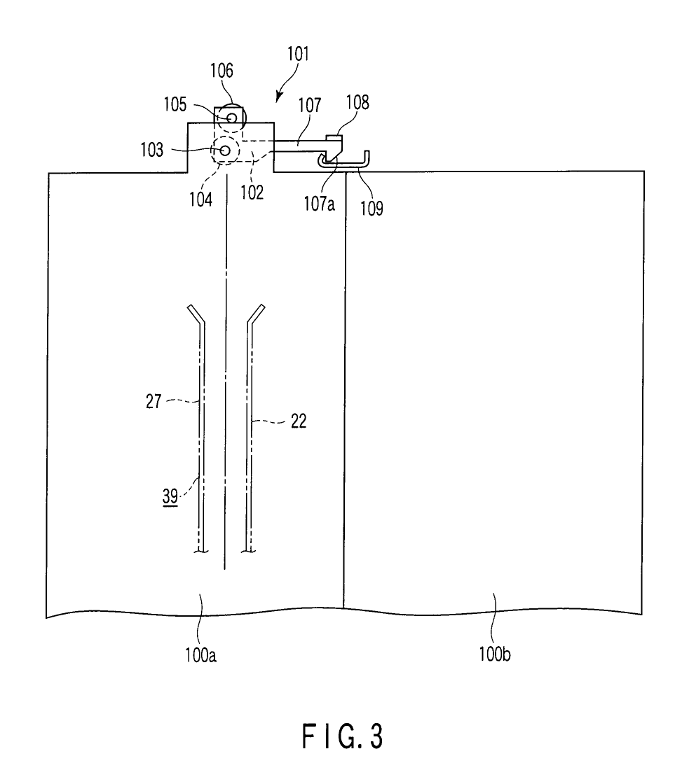

FIG. 3 shows the hall door device and its locking mechanism. The hall door device is provided with a pair of center-opening hall doors 100a and 100b, which open and close the entrance of the elevator hall. The hall doors 100a and 100b can move bisymmetrically in linkage with each other.

The hall door 100a is provided with a locking mechanism 101. The locking mechanism 101 includes an L-shaped hook lever 102, a first engaging roller 104 as an engaging element, and a second engaging roller 106 as another engaging element. The first engaging roller 104 is rotatably attached to a bent portion of the hook lever 102 by a shaft 103. The second engaging roller 106 is rotatably attached to one end portion of the lever 102 by a shaft 105. The hook lever 102 is rockably mounted on the hall door 100a by the shaft 103. The other end side of the lever 102 constitutes an engaging piece 107 that extends sideways from the first engaging roller 104. A hooklike engaging claw 107a is formed on the distal end portion of the engaging piece 107.

The second engaging roller 106 is located over the first engaging roller 104. The hook lever 102 is urged to rock counterclockwise by a weight 108 that is provided on the distal end portion of the engaging piece 107. The range of rocking motion of the engaging piece 107 is regulated so that the engaging piece 107 can be held substantially horizontal by a stopper (not shown).

As the car ascends or descends, the pair of engaging rollers 104 and 106 relatively get into a gap between the first and second engaging vanes 22 and 27 of the car. Further, the frame member (not shown) of the hall door device is provided with an engaging portion 109 for engagement with the hook lever 102.

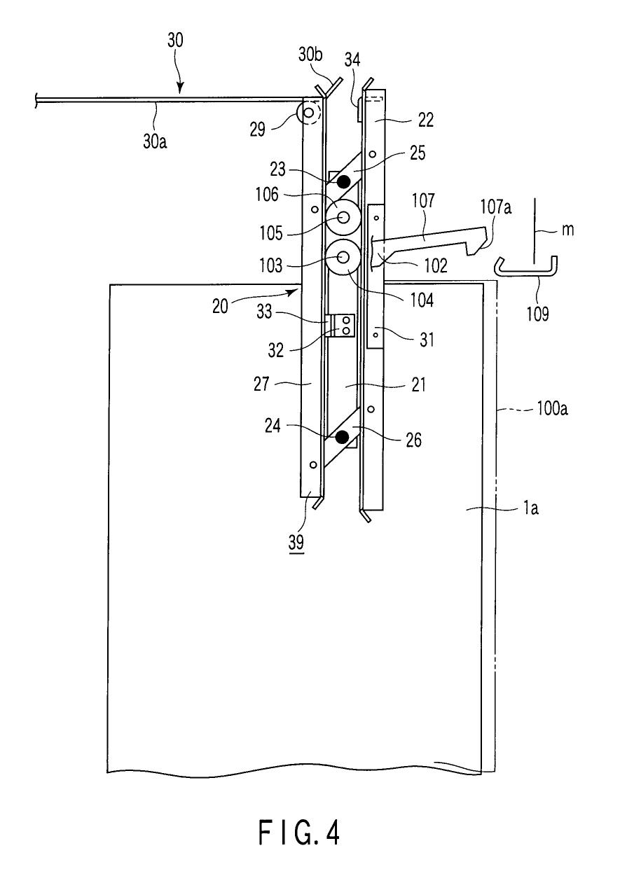

The operation of the present invention arranged in this manner will now be described with reference to FIGS. 4 to 7. The car door 1a is moved in the closing direction by a driving force produced by the drive unit 4 in the order shown in FIGS. 4 to 7. The shafts 23 and 24 that are fixed to the car door 1a are represented by solid black circles.

FIG. 4 shows a state in which the car has arrived at the elevator hall and stopped there and the car doors 1a and 1b face the hall door as they move in the closing direction from an open state.

As this is done, the pair of engaging rollers 104 and 106 of the hall door get into the gap between the first and second engaging vanes 22 and 27 of the car door 1a. Illustrated line m represents a door-stop position reached when the center-opening doors are closed.

In this state, the cam roller 29 is in contact with the lower surface of the horizontal portion 30a of the cam plate 30. Therefore, the second engaging vane 27 is pressed down against the load of the balance weight 31. Thus, the closed state is maintained so that the clearance between the first and second engaging vanes 22 and 27 is narrow.

Further, the first and second engaging rollers 104 and 106 are pinched and restrained by the first and second engaging vanes 22 and 27. As this is done, the car door 1a and the hall door 100a are caused to engage each other. As the car door 1a moves in its closing direction, therefore, the hall door 100a moves integrally with the car door 1a in its closing direction.

When the first and second engaging rollers 104 and 106 are pinched between the first and second engaging vanes 22 and 27, moreover, the engaging piece 107 of the hook lever 102 is somewhat inclined upward so that its distal end portion is raised.

Further, the second engaging vane 27 is in close contact with the magnet 33. The magnetic attraction of the magnet 33 stably maintains the state of the engaging rollers 104 and 106 pinched by the two engaging vanes 22 and 27.

The door apparatus is constructed so that the distal end edge of the hall door 100a on its door-stop side is situated somewhat ahead (e.g., 14 mm ahead) of the respective distal end edges of the car doors 1a and 1b on the door-stop side.

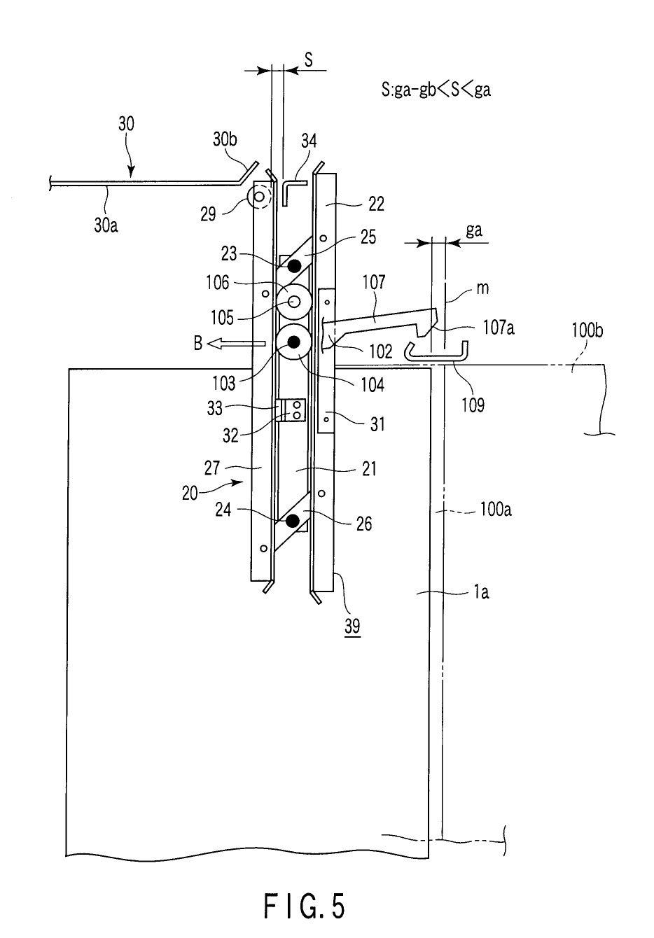

As the car door 1a advances in the closing direction, it soon reaches the position shown in FIG. 5. As this is done, the hall doors 100a and 100b reach the door-stop position m. Further, the respective distal end edges of the hall doors on the door-stop side abut against each other and stop to establish the closed state. As this is done, the distal end edge of the car door 1a reaches a position at some distance ga (e.g., 14 mm as described above) from the door-stop position m.

When the state shown in FIG. 5 is attained, the shaft 103 of the first engaging roller 104 reaches an immovable stop position. Thereafter, the car door 1a further moves in the closing direction. In response to this movement, the second engaging vane 27 that is attached to the car door 1a receives a reaction force in the direction of arrow B from the first engaging roller 104 on the hall door 100a in a stopped state. In FIG. 5, the shaft 103 is represented by a solid black circle in order to indicate that the first engaging roller 104 is immovable.

The cam roller 29 reaches the slope portion 30b of the cam plate 30 before the hall door 100a reaches the door-stop position m. At this point of time, the ascent of the second engaging vane 27 is suppressed by the magnetic attraction of the magnet 33. Thus, the cam roller 29 moves directly in the closing direction without contacting the slope portion 30b.

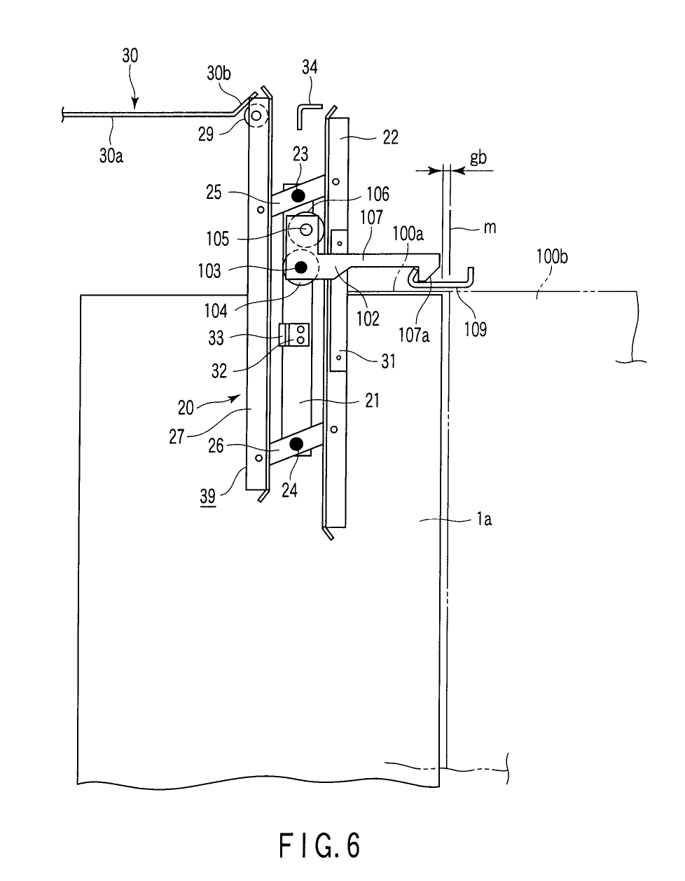

When the car door 1a further moves in the closing direction, the link plate 26 is pressed in the direction of arrow B by the aforesaid reaction force. This pressing force surpasses the magnetic attraction of the magnet 33. Accordingly, the second engaging vane 27 leaves the magnet 33, as shown in FIG. 6. Further, the magnetic attraction of the magnet 33 that acts on the second engaging vane 27 disappears. The link plates 25 and 26 are rocked clockwise by the load of the balance weight 31. Furthermore, the first engaging vane 22 descends, while the second engaging vane 27 ascends. As a result, the clearance between the engaging vanes 22 and 27 widens, whereupon the engaging roller 106 is released from the restraint.

Thus, the hook lever 102, along with the engaging roller 106, rocks clockwise around the shaft 103, whereupon the engaging claw 107a of the engaging piece 107 engages the engaging portion 109. The hall door 100a is locked by this engagement.

While the second engaging vane 27 is ascending, the cam roller 29 is situated corresponding to the slope portion 30b of the cam plate 30. Therefore, the second engaging vane 27 is allowed to ascend without being restricted by the plate 30.

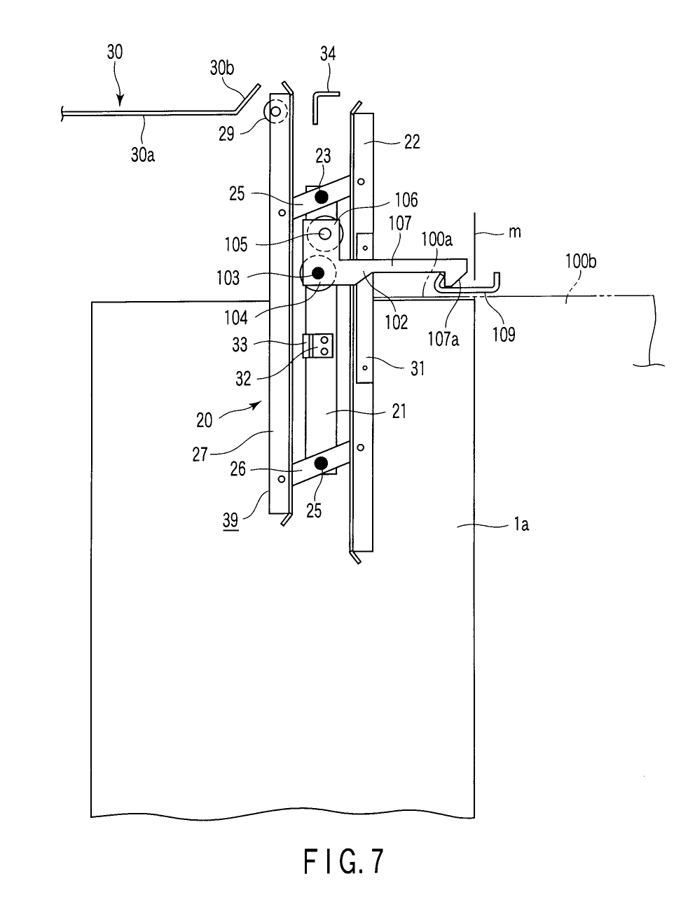

Also when this state is reached, the car door 1a leaves some distance gb (e.g., 12 mm) from the door-stop position m. Further, the car door 1a moves to the door-stop position m, as shown in FIG. 7, whereupon the closing operation is completed. The cam roller 29 is disengaged from the slope portion 30b of the cam plate 30 by this movement. Thus, contact between the cam roller 29 and the slope portion 30b can be avoided while the car is ascending or descending, so that the car can ascend and descend smoothly.

In this manner, the engagement between the car door 1a and the hall door 100a can be maintained for the transmission of the driving force from the car door 1a to the hall door 100a until the door 100a reaches the door-stop position m. Thus, the hall door 100a can be accurately closed up without being subjected to any strong self-closing force by a closer. While the car door 1a is advancing to the door-stop position m, the locking mechanism 101 can be actuated, and the car door 1a and the hall door 100a can be disengaged from each other.

Thus, according to the prior art technique, the second engaging vane 27 ascends so that the cam roller 29 moves along the slope portion 30b of the cam plate 30 when it reaches the slope portion 30b before the hall door 100a reaches the door-stop position m. Then, the two engaging vanes 22 and 27 open, whereupon the car door 1a and the hall door 100a are disengaged from each other. After this is done, therefore, the hall door 100a must be moved to the door-stop position m by the force of the closer. In the present embodiment, on the other hand, the ascent of the second engaging vane 27 is restrained by the magnetic attraction of the magnet 33 even when the position of the slope portion 30b of the cam plate 30 is reached by the cam roller 29. Thus, the closed state of the two engaging vanes 22 and 27, that is, the engagement of the car door 1a and the hall door 100a, can be maintained as it is. After the hall door 100a then reaches the door-stop position m and stops there, the engaging vanes 22 and 27 are opened by the reaction force B. Thereupon, the car door 1a and the hall door 100a are disengaged from each other, and the car door 1a moves to the door-stop position m. According to the present embodiment, therefore, the hall door 100a can be accurately closed up without being subjected to any strong self-closing force by the closer.

The following is a description of the operation of the cam roller 29. As the door is closed, the cam roller 29 moves horizontally along the horizontal portion 30a of the cam plate 30 and reaches the slope portion 30b. Also in this position, the ascent of the second engaging vane 27 is restrained by the magnetic attraction of the magnet 33. Thus, the cam roller 29 directly moves in the horizontal direction and leaves the slope portion 30b.

When the car door 1a further moves in the closing direction and reaches the position gb short of the door-stop position m, as shown in FIG. 6, the second engaging vane 27 leaves the magnet 33. Then, the link plates 25 and 26 are rocked clockwise by the load of the balance weight 31. As this is done, the engaging vanes 22 and 27 open away from each other, and the second engaging vane 27 ascends. In consequence, the cam roller 29 is located close to or in contact with the slope portion 30b of the cam plate 30. Thereafter, the car door 1a reaches the door-stop position m and is closed securely, as shown in FIG. 7. As this is done, the cam roller 29 leaves the slope portion 30b.

When the hall door 100a reaches the door-stop position m, as shown in FIG. 5, the cam roller 29 is kept at a distance s from the roller stopper 34. This distance s is given by ga−gb<s<ga.

In some cases of maintenance and inspection or adjustment for the car door 1a, the car door 1a may be singly opened or closed without engagement with the hall door 100a. In one such case, the cam roller 29 is configured to abut against the roller stopper 34 before the car door 1a moved from the position gb reaches the door-stop position m, where it is fully closed. Although both the engaging vanes 22 and 27 are closed during operation for the maintenance and inspection or adjustment, therefore, the cam roller 29 abuts against the roller stopper 34 so that the engaging vanes 22 and 27 open immediately before the car door 1a is closed up. Thus, the car door 1a cannot be closed with the vanes 22 and 27 kept closed. When the car door 1a is closed, therefore, the clearance between the engaging vanes 22 and 27 never fails to maintain a predetermined width that allows penetration of the engaging rollers 104 and 106 of the hall door 100a.

When the car door 1a is located wide apart from the door-stop position m, as shown in FIG. 4, moreover, the cam roller 29 gets under the horizontal portion 30a of the cam plate 30. If the hall door 100a or the car door 1a runs against any obstacle as the car door 1a is closed, therefore, the link plates 25 and 26 never rotate clockwise. Accordingly, normal overload avoiding operation can be performed smoothly.

The following is a description of operation for opening the door.

When the car arrives at the elevator hall, the state shown in FIG. 7 is established. In this state, the car door 1a is driven to move in the opening direction or to the left. In response to this movement, the first engaging vane 22 engages the second engaging roller 106. As this is done, the engaging roller 106 rocks counterclockwise around the shaft 103. Thus, the hook lever 102 and the engaging portion 109 are disengaged from each other, whereupon the hall door is unlocked.

When the car door 1a further moves to the left, the cam roller 29 abuts against the slope portion 30b of the cam plate 30. The slope portion 30b applies a downward pressing force to the cam roller 29. As the car door 1a further moves, the cam roller 29 moves along the slope portion 30b of the cam plate 30. As this is done, the cam roller 29 is pushed in downward, whereupon the link plates 25 and 26 rotate counterclockwise against the load of the balance weight 31. The cam roller 29 soon reaches the horizontal portion 30a of the cam plate 30 and gets under it. Thereupon, the second engaging vane 27 is further pushed in downward by the cam roller 29, and the link plates 25 and 26 rock counterclockwise. Thus, the engaging vanes 22 and 27 are closed together to pinch the engaging rollers 104 and 106 between them, and the second engaging vane 27 comes into close contact with the magnet 33. Door opening is achieved when the car door 1a moves to the left in this state.

Thus, according to the present embodiment, both the engaging vanes 22 and 27 are stably held by the magnetic attraction of the magnet 33 in a position where they accurately engage the engaging rollers 104 and 106. When the car door 1a is closed, this state of engagement is stably held by the magnetic attraction of the magnet 33 until the hall door 100a reaches the door-stop position. Therefore, the driving force produced by the car door 1a can be accurately applied to the hall door 100a. Accordingly, it is unnecessary to enhance the force of the closer that applies a self-closing force to the hall door 100a. Even if a drag that acts on the hall door 100a increases, moreover, the door 100a can be securely closed up without failing to maintain an appropriate door closing force.

After the hall door 100a is closed up and stopped, the engaging vanes 22 and 27 are accurately moved away from the engaging rollers 104 and 106 by the load of the balance weight 31. As this is done, the engaging vanes 22 and 27 are accurately disengaged from the engaging rollers 104 and 106, and this release state is stably maintained by the load of the balance weight 31.

When the car door 1a is closed, moreover, the cam roller 29 closely faces the roller stopper 34. Thus, the second engaging vane 27 is restrained from moving toward the first engaging vane 22. If the car door 1a is operated without engagement with the hall door 100a at the time of maintenance and inspection or adjustment, therefore, the second engaging vane 27 is restrained from moving toward the first engaging vane 22. Accordingly, a disadvantage can be prevented such that the clearance between the second engaging vane 27 and the first engaging vane 22 is narrower than the predetermined width. Thus, collision between the second engaging vane 27 and the engaging rollers 104 and 106 can be avoided to ensure safety as the car ascends or descends after the maintenance and inspection or adjustment.

Also if the door runs against any obstacle as it is closed, moreover, the second engaging vane 27 can be prevented from moving. Therefore, there is no possibility of vibration or unstable operation occurring. Thus, overload avoiding operation can be performed smoothly during the door closing operation.

Further, the car doors 1a and 1b can be attached directly to the door drive belt 5. Therefore, the position of the belt 5 and the respective positions of the doors 1a and 1b can be aligned accurately. Thus, there is no need of any dedicated connecting mechanism for synchronously aligning the positions of the two doors 1a and 1b, so that the system can be simplified.

Furthermore, the engaging device according to the present embodiment hardly differs from a conventional engaging device in installation space. Therefore, the engaging device can be easily attached to even a previously installed elevator.

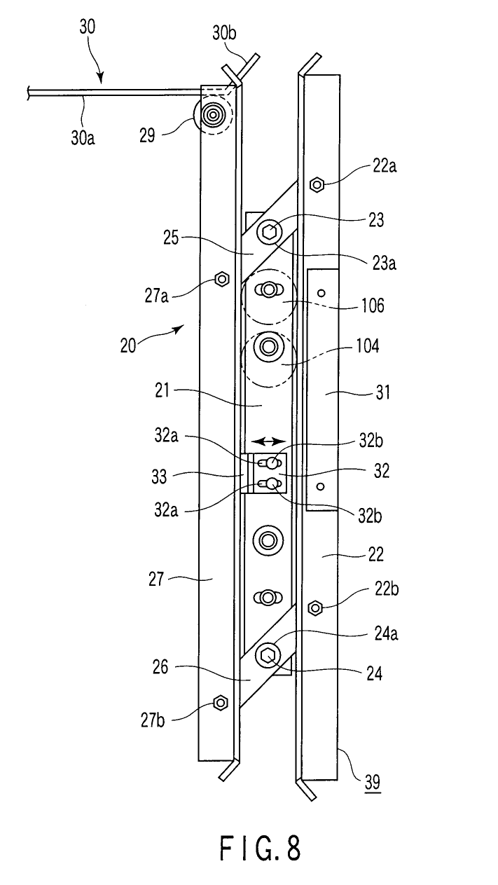

A second embodiment of the present invention will now be described with reference to FIG. 8. Like numerals are used to designate the same elements as those of the first embodiment, and a repeated description thereof is omitted.

When engaging vanes 22 and 27 that are translated in opening and closing directions are closed together to pinch engaging rollers 104 and 106 between them, their closing width must be adjusted so that a cam roller 29 is in contact with a horizontal portion 30a of a cam plate 30 and that the second engaging vane 27 is accurately in close contact with a magnet 33.

According to the present embodiment, therefore, a plurality of laterally elongated slots 32a are formed in a bracket 32 that supports the magnet 33. Screws 32b are screwed into a base plate 21 through the slots 32a. By tightening these screws 32b, the bracket 32 is fixed to the base plate 21 so that the magnet 33 can be located in a predetermined position.

According to this arrangement, the bracket 32 can be slid along the slots 32a if the screws 32b are loosened. When the two engaging vanes 22 and 27 are closed together to pinch the engaging rollers 104 and 106 between them as this is done, the magnet 33 is positioned and fixed in a position such that the second engaging vane 27 is accurately in close contact with the magnet 33. Thus, the closing width of both the engaging vanes 22 and 27 can be easily adjusted to an appropriate width.

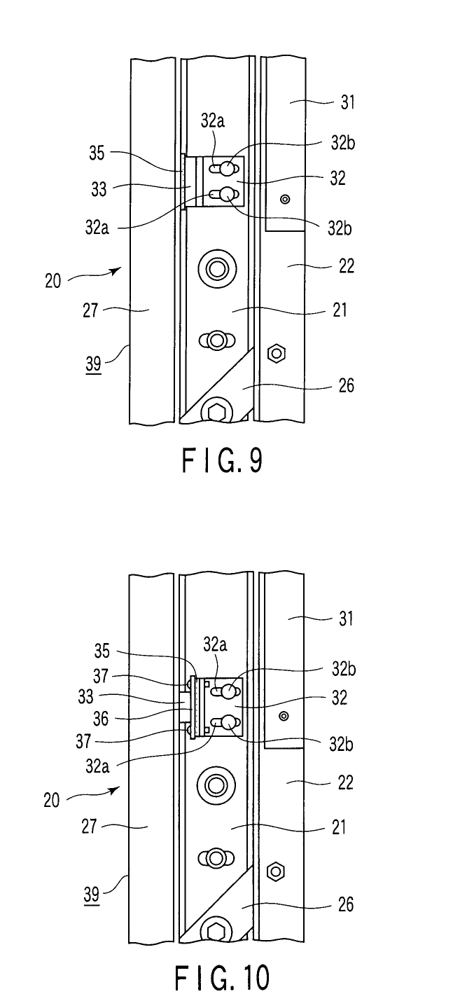

FIG. 9 shows a third embodiment. In this embodiment, as in the second embodiment described above, a bracket 32 that supports a magnet 33 can be adjusted for lateral movement. Further, a rubber sheet 35, as an example of impact damping means, is attached to that part of a second engaging vane 27 which is in close contact with a magnet 33.

According to this arrangement, an impact caused when the second engaging vane 27 collides and closely contacts with the magnet 33 is absorbed and damped by elastic deformation of the rubber sheet 35. Thus, a noise attributable to this impact can be suppressed.

FIG. 10 shows a fourth embodiment. In this embodiment, as in the second embodiment described before, a bracket 32 can be adjusted for lateral movement. Further, a magnet 33 is attached to a flat plate 36. Furthermore, the plate 36 sandwiches a rubber sheet 35 as impact damping means therein and is attached to the bracket 32 by a plurality of screws 37. Each screw 37 is loosely fitted in the plate 36. The tip end portion of the screw 37 is threadedly attached to the bracket 32. Thus, the plate 36 is movable toward and away from the bracket 32.

Also in the case of this embodiment, an impact caused when a second engaging vane 27 engages and closely contacts with the magnet 33 is absorbed and damped by elastic deformation of the rubber sheet 35. Thus, noise attributable to this impact can be suppressed.

In the third and fourth embodiments described above, moreover, the rubber sheet 35 for use as impact damping means are elastically deformed so as to be compressed when the second engaging vane 27 engages and closely contacts with the magnet 33. If there is any error in the mounting position of the magnet 33, therefore, the error is absorbed by elastic deformation of the rubber sheet 35. Thus, the position can be easily adjusted when the magnet 33 is mounted.

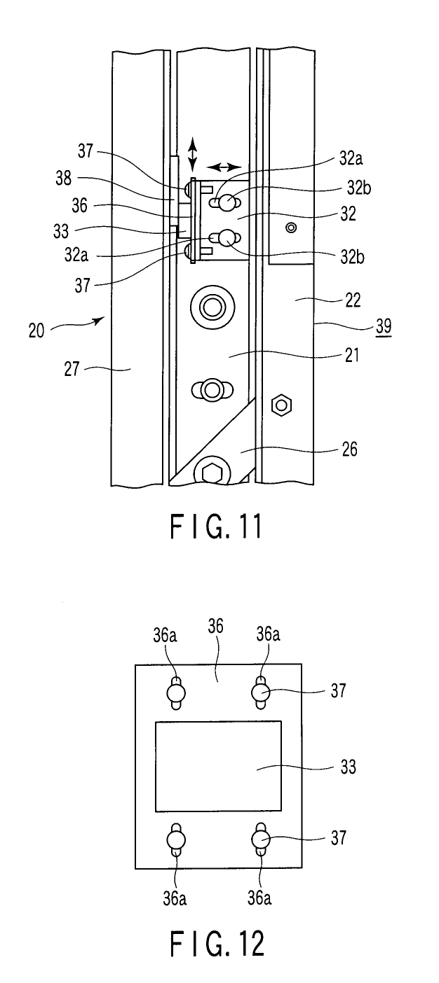

FIG. 11 shows a fifth embodiment. In this embodiment, as in the second embodiment described before, a bracket 32 that supports a magnet 33 can be adjusted for lateral movement. Further, the magnet 33 is attached to a flat plate 36. The plate 36 is attached to the bracket 32 by a plurality of screws 37. As shown in FIG. 12, a plurality of vertically elongated slots 36a are formed in the plate 36. The screws 37 are loosely fitted in the slots 36a. The respective tip end portions of the screws 37 are threadedly attached to the bracket 32.

Further, an engaging vane 27 is fitted with an attraction plate 38 that has a fixed area. The magnet 33 can come into close contact with a surface of the attraction plate 38.

According to this arrangement, the plate 36 can be vertically moved together with the magnet 33 if the screws 37 are loosened. Further, the area of close contact between the magnet 33 and the attraction plate 38 can be changed if the plate 36, along with the magnet 33, is located in a predetermined position and fixed by the screws 37. Further, the magnetic attraction of the magnet 33 that acts on the attraction plate 38, that is, a retention force for holding two engaging vanes 22 and 27 in a closed state, can be adjusted.

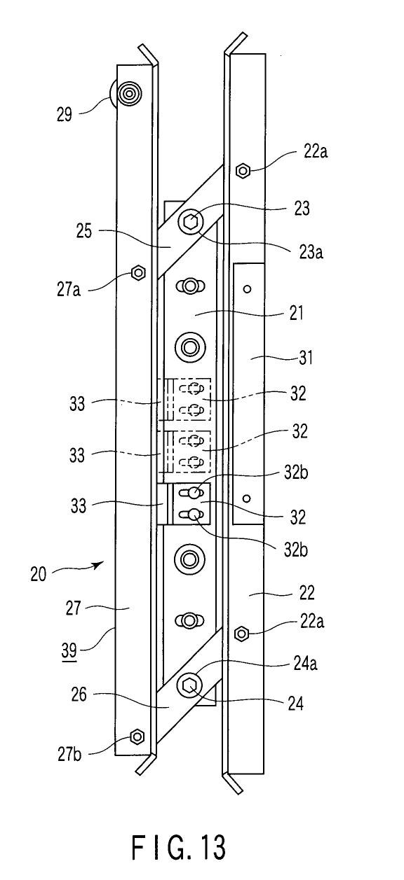

FIG. 13 shows a sixth embodiment. In this embodiment, a base plate 21 of a car door can be fitted with a plurality of magnets 33, which are constructed in the same manner as in the case of the second embodiment. By varying the number of magnets 33 to be attached to the base plate 21, the magnetic attraction that acts on an engaging vane 27 can be changed, whereby a retention force for holding two engaging vanes 22 and 27 in a closed state can be adjusted.

Depending on site conditions of a building, for example, the difference in pressure between the elevator shaft and elevator hall may be so much greater than usual that it is difficult for one magnet 33 to secure a satisfactory retention for holding the two engaging vanes 22 and 27 in the closed state. In such a case, an increase of the pressure difference can be coped with by additionally attaching another magnet 33 to the base plate 21, thereby increasing the magnetic attraction and enhancing the retention force.

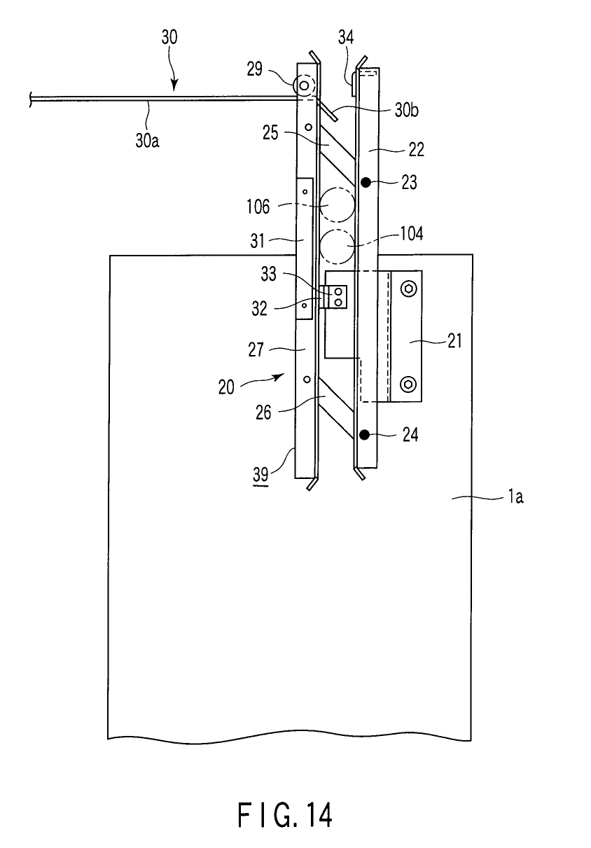

FIG. 14 shows a seventh embodiment. In this embodiment, a first engaging vane 22 located on the door closing direction side of the car door 1a, out of the two engaging vanes 22 and 27, is fixedly attached to a base plate 21 of the car door 1a.

Respective one end portions of link plates 25 and 26 are rockably mounted on the first engaging vane 22 by shafts 23 and 24. The second engaging vane 27 is rockably mounted on the respective other end portions of the link plates 25 and 26. These elements constitute a parallel link mechanism. Only the second engaging vane 27 is configured to be translated vertically and laterally with respect to the fixed first engaging vane 22.

The link plates 25 and 26, in contrast with those of the foregoing embodiments, are inclined downward to the right. When the second engaging vane 27 moves downward, an open state is established such that the clearance between the second engaging vane 27 and the first engaging vane 22 widens. When the second engaging vane 27 moves upward, on the other hand, a closed state is established such that the clearance between the second engaging vane 27 and the first engaging vane 22 narrows.

A balance weight 31 as urging means is attached to the second engaging vane 27. The balance weight 31 urges the engaging vane 27 to open with respect to the first engaging vane 22.

A magnet 33 for use as a retention mechanism is attached to the base plate 21 by a bracket 32 so as to face the second engaging vane 27. The magnetic attraction of the magnet 33 serves to maintain a closed state such that the two engaging vanes 22 and 27 are closed together to pinch engaging rollers 104 and 106 between them.

A cam roller 29 as a cam mechanism of this embodiment is located on the upper surface side of a cam plate 30. A slope portion 30b of the cam plate 30, in contrast with those of the foregoing embodiments, is inclined downward to the right. The two engaging vanes 22 and 27 are held in the closed state with the cam roller 29 in contact with the upper surface of a horizontal portion 30a of the cam plate 30.

In this embodiment, as in the cases of the foregoing embodiments, the two engaging vanes 22 and 27 pinch the engaging rollers 104 and 106 between them to release a locking mechanism (not shown) of a hall door. In this state, the cam roller 29 moves to the slope portion 30b of the cam plate 30 immediately before the hall door moves in the door closing direction and reaches the door-stop position. Thereupon, the maintenance of the closed state of the two engaging vanes 22 and 27 by the cam mechanism is canceled. The closed state of the two engaging vanes 22 and 27 is maintained as it is by the magnetic attraction produced by the magnet 33.

When the hall door reaches the door-stop position and stops there, the maintenance of the closed state by the magnet 33 is canceled by its reaction force. Thereupon, the two engaging vanes 22 and 27 open, the engaging roller 106 is displaced with respect to the first engaging roller 104, and the locking mechanism of the hall door is actuated to lock the hall door.

Thus, the engagement between the car door 1a and the hall door can be maintained until the hall door reaches the door-stop position, and the driving force produced by the car door 1a can be transmitted to the hall door. Therefore, the hall door can be accurately closed up without being subjected to any strong self-closing force by the closer.

In each of the foregoing embodiments, moreover, the second engaging vane is attracted by the magnet for use as the retention mechanism so that both the engaging vanes can be held in the closed state. Alternatively, however, both the engaging vanes may be held in the closed state by attracting the first engaging vane by the magnet or attracting the link plates that constitute the parallel link mechanism by the magnet.

Although the balance weight is used as the urging means that urges the engaging vanes in the opening direction according to each of the foregoing embodiments, furthermore, a spring member may be used in place of the balance weight.

The present invention is not limited to the embodiments described above but may also be applied to, for example, a single-opening door. Further, the present invention may also be applied to an automatic door or the like that causes a door on a station platform to engage a door of a train car, for example.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A door apparatus including an engaging device which causes one of car doors and one of hall doors to engage each other, the door apparatus comprising:
urging means which urges a first engaging vane and a second engaging vane provided on the one of the car doors in an opening direction;
a cam mechanism which holds the first engaging vane and the second engaging vane in a closed state, resisting the urging means, and cancels the maintenance of the closed state immediately before the hall doors reach a door-stop position after moving in a door closing direction; and
a retention mechanism which holds the first engaging vane and the second engaging vane in the closed state, resisting the urging means, maintains the closed state of the first engaging vane and the second engaging vane even after the maintenance of the closed state by the cam mechanism is canceled, and cancels the maintenance of the closed state by means of a reaction force in response to stopping of the hall doors by door abutting.

2. A door apparatus according to claim 1, comprising a locking mechanism for locking the hall doors in a locked state.

3. An elevator door apparatus comprising:
sliding-type car doors which open and close an entrance of a car;
sliding-type hall doors which open and close an entrance of an elevator hall and of which respective distal end edges on the door-stop side move in association with the car doors in the door closing direction, preceding respective distal end edges of the car doors on the door-stop side;
a drive unit for driving one of the car doors and a locking mechanism for locking the hall doors in a locked state; and
an engaging device which causes one of the car doors and one of the hall doors to engage each other by operating the one car door in a state such that the car arrives at the elevator hall, thereby transmitting a driving force of one of the car doors to one of the hall doors and actuating the locking mechanism in response to release of the engagement,
the engaging device including
a first engaging element which is provided on one of the hall doors and transmits the driving force of the one of the car doors to the one of the hall doors
a second engaging element which is also provided on the one of the hall doors and is displaced relatively to the first engaging element, thereby actuating the locking mechanism,
an engaging vane mechanism which includes a first engaging vane and a second engaging vane provided on the one of the car doors and configured to be translated toward and away from each other in closing and opening directions by a parallel link mechanism, such that the first engaging vane and the second engaging vane are moved toward each other to be closed together, whereby the first engaging element and the second engaging element are pinched between the two engaging vanes so that the second engaging element is held in a position where the locking mechanism is released, and that the first and second engaging vanes are moved away from each other to be opened as the hall doors are stopped by door abutting, whereby the first engaging element and the second engaging element are released from the pinch so that the locking mechanism is actuated,
urging means which urges the first and second engaging vanes in the opening direction,
a cam mechanism which holds the first engaging vane and the second engaging vane in a closed state, resisting the urging means, and cancels the maintenance of the closed state immediately before the hall doors reach a door-stop position after moving in a door closing direction, and
a retention mechanism which holds the first engaging vane and the second engaging vane in the closed state, resisting the urging means, maintains the closed state of the first engaging vane and the second engaging vane even after the maintenance of the closed state by the cam mechanism is canceled, and cancels the maintenance of the closed state by means of a reaction force in response to stopping of the hall doors by door abutting.

4. An elevator door apparatus according to claim 3, wherein the urging means urges the first engaging vane and the second engaging vane in the opening direction by means of a balance weight or a spring member.

5. An elevator door apparatus according to claim 3, wherein the retention mechanism holds the first engaging vane and the second engaging vane in the closed state by means of the magnetic attraction of a magnet.

6. An elevator door apparatus according to claim 5, wherein the retention mechanism is provided on one of the car doors so as to face the first engaging vane or the second engaging vane and holds both the engaging vanes in the closed state by coming into close contact with the first engaging vane or the second engaging vane by means of magnetic attraction.

7. An elevator door apparatus according to claim 5, wherein the magnet is configured to be adjusted in mounting position in order to adjust a closing width of the two engaging vanes.

8. An elevator door apparatus according to claim 6, wherein impact damping means is provided between the magnet and the first engaging vane or the second engaging vane and/or between the magnet and a magnet support portion in order to suppress an impact noise caused when the magnet come into close contact with the first engaging vane or the second engaging vane.

9. An elevator door apparatus according to claim 6, wherein the magnet is configured to be adjusted in mounting position so that an area of close contact with the first engaging vane or the second engaging vane is changed to enable adjustment of a retention force for holding the two engaging vanes in the closed state by adjusting the mounting position.

10. An elevator door apparatus according to claim 6, wherein the car doors are configured to be fitted with a plurality of magnets such that a retention force for holding the two engaging vanes in the closed state is adjustable by increasing or reducing the magnets in number.

11. An elevator door apparatus according to claim 3, wherein the engaging vane located on the door closing direction side of the car door, out of the two engaging vanes, is fixed to the car door, and the other engaging vane is translated by the parallel link mechanism.
